(19) United States
(12) Patent Application Publication
(10) Pub. No.: US 2023/0282409 A1
(43) Pub. Date: Sep. 7, 2023

(54) PRESS-FIT WIRE AND MAGNETIC DEVICE

(71) Applicant: Delta Electronics, Inc., Taoyuan City (TW)

(72) Inventors: Huai-Pei TUNG, Taoyuan City (TW); Chun-Ching YEN, Taoyuan City (TW); Bai-Xue XU, Taoyuan City (TW); Chun-Yu YANG, Taoyuan City (TW); Te-Chih PENG, Taoyuan City (TW); Kuo-Hsun CHIEN, Taoyuan City (TW); Yung-Chin WANG, Taoyuan City (TW); Chao-Fong CHANG, Taoyuan City (TW)

(21) Appl. No.: 17/826,313

(22) Filed: May 27, 2022

(30) Foreign Application Priority Data
Mar. 1, 2022 (CN) 202210194042.8

(51) Int. Cl. H01F 27/30; H01F 27/28; H01F 27/24

(52) U.S. Cl. CPC H01F 27/306; H01F 27/2823; H01F 27/24

(57) ABSTRACT

A press-fit wire disposed in a magnetic device is provided. The press-fit wire includes a first wire and a second wire. The second wire is attached to the first wire. The first wire and the second wire are arranged along a first direction and are parallel circuits. The first wire and/or the second wire is a multi-strand wire.

### CROSS REFERENCE TO RELATED APPLICATIONS

This application claims the benefit of China Patent Application No. 202210194042.8, filed Mar. 1, 2022, the entirety of which is incorporated by reference herein.

### BACKGROUND OF THE INVENTION

### Field of the Invention

The application relates in general to a press-fit wire, and in particular, to a press-fit wire to be used on a magnetic device.

### Description of the Related Art

There are a lot of electronic components in an electronic apparatus, an important one being the transformer. A transformer is primarily used to transform the drive voltage used by circuits. For example, a power transformer can lower voltage, and step-up transformers in an AC adapter module of a notebook computer can raise the operating voltage of the circuits. Therefore, there are various types of transformers, made for various functions. Most transformers are customized according to the needs of customers.

Another electronic component commonly found in electronic apparatuses is the inductor. Since consumer electronic apparatuses have been miniaturized and are currently being made thinner, the electronic component cannot usually provide sufficient efficacy. Therefore, how to address the aforementioned problem has become an important issue.

### BRIEF SUMMARY OF INVENTION

To address the deficiencies of conventional products, an embodiment of the invention provides a press-fit wire disposed in a magnetic device, including a first wire and a second wire attached to the first wire. The first wire and the second wire are arranged along a first direction and are parallel circuits. The first wire and/or the second wire is a multi-strand wire.

In some embodiments, the first wire is a multi-strand wire having a plurality of first lines, and the first lines are arranged in a matrix.

In some embodiments, the second wire is a multi-strand wire having a plurality of second lines, the second lines are arranged in a matrix, and the number of second lines is the same as the number of first lines. In some embodiments, the number of second lines is different from the number of first lines.

In some embodiments, the first wire has at least one first line, the second wire has at least one second line, and the diameter of the first line is different from the diameter of the second line.

In some embodiments, the first wire or the second wire has a single line.

In some embodiments, the press-fit wire further includes a third wire, and the first wire, the second wire, and the third wire are arranged along the first direction.

In some embodiments, the press-fit wire has a first end and a second end opposite to the first end, the second wire is disposed between the first wire and the third wire at the first end, and the second wire is disposed between the first wire and the third wire at the second end.

In some embodiments, the press-fit wire has a first end and a second end opposite to the first end, the second wire is disposed between the first wire and the third wire at the first end, and the third wire is disposed between the first wire and the second wire at the second end.

In some embodiments, the first wire and the second wire are affixed to each other by adhering or welding.

In some embodiments, in a second direction that is perpendicular to the first direction, the first wire and the second wire substantially have the same height.

A magnetic device is also provided, including an upper magnetic core, a lower magnetic core, and the aforementioned press-fit wire. The upper magnetic core and the lower magnetic core respectively include a first protruding portion and a second protruding portion. The first protruding portion and the second protruding portion form a central pillar, and the press-fit wire surrounds the central pillar. In detail, the third wire surrounds the central pillar, the second wire surrounds the third wire, and the first wire surrounds the second wire.

### BRIEF DESCRIPTION OF DRAWINGS

The invention can be more fully understood by reading the subsequent detailed description and examples with references made to the accompanying drawings, wherein:

FIG. 1 is a schematic diagram of a magnetic device according to an embodiment of the invention;

FIG. 2 is an exploded-view diagram of the magnetic device according to an embodiment of the invention;

FIG. 3A is a schematic diagram of a press-fit wire according to an embodiment of the invention;

FIG. 3B is a cross-sectional view taken along the line A-A in FIG. 3A;

FIG. 3C is a cross-sectional view taken along the line B-B in FIG. 3A;

FIG. 4A is a schematic diagram of a press-fit wire according to another embodiment of the invention;

FIG. 4B is a cross-sectional view taken along the line C-C in FIG. 4A;

FIG. 4C is a cross-sectional view taken along the line D-D in FIG. 4A;

FIG. 5A is a schematic diagram of a press-fit wire according to another embodiment of the invention;

FIG. 5B is a cross-sectional view taken along the line E-E in FIG. 5A;

FIG. 6A is a schematic diagram of a press-fit wire according to another embodiment of the invention;

FIG. 6B is a cross-sectional view taken along the line F-F in FIG. 6A;

FIG. 7 is a cross-sectional view taken along the line G-G in FIG. 1; and

FIG. 8 is a schematic diagram of a magnetic device according to another embodiment of the invention.

### DETAILED DESCRIPTION OF INVENTION

The making and using of the embodiments of the press-fit wire and the magnetic device having the press-fit wire are discussed in detail below. It should be appreciated, however, that the embodiments provide many applicable inventive concepts that can be embodied in a wide variety of specific contexts. The specific embodiments discussed are merely illustrative of specific ways to make and use the embodiments, and do not limit the scope of the disclosure.

Unless defined otherwise, all technical and scientific terms used herein have the same meaning as commonly understood by one of ordinary skill in the art to which this invention belongs. It should be appreciated that each term, which is defined in a commonly used dictionary, should be interpreted as having a meaning conforming to the relative skills and the background or the context of the present disclosure, and should not be interpreted in an idealized or overly formal manner unless defined otherwise.

The following disclosure provides many different embodiments, or examples, for implementing different features of the subject matter provided. Specific examples of solutions and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. Furthermore, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

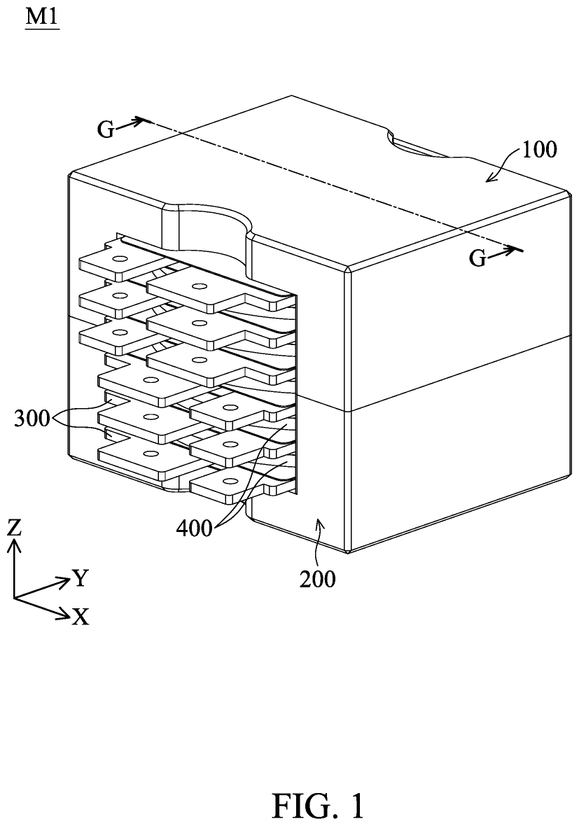

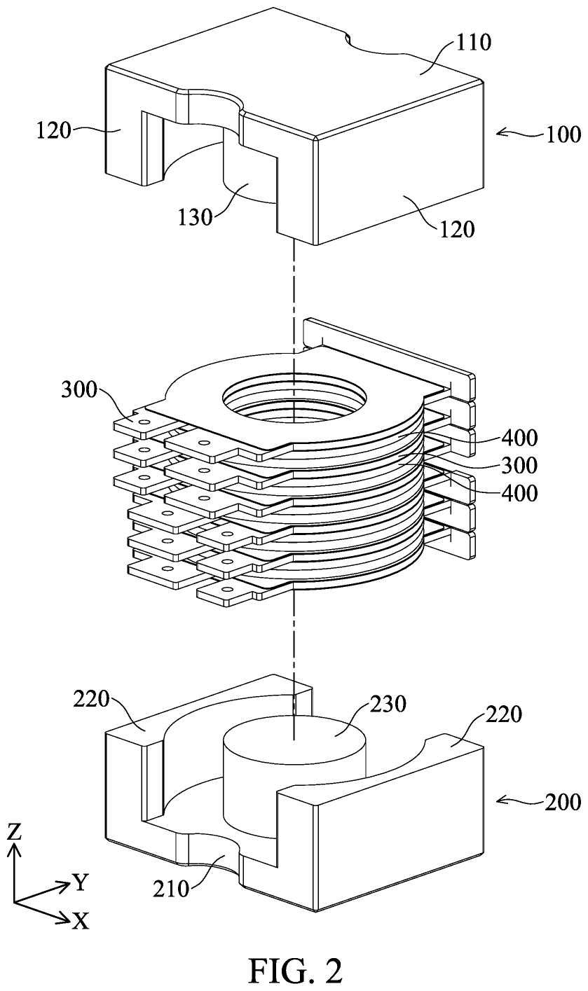

Referring to FIG. 1 and FIG. 2, a magnetic device M1 in an embodiment of the invention primarily includes an upper magnetic core 100, a lower magnetic core 200, at least one press-fit wire 300, and at least one coil 400. The upper magnetic core 100 and the lower magnetic core can be engaged with each other, and the press-fit wire 300 can be disposed between the upper magnetic core 100 and the lower magnetic core 200. In this embodiment, the magnetic device M1 can be a transformer. When current flows into the magnetic device M1, the magnetic M1 can output current with different voltage by electromagnetic induction. In some embodiments, the magnetic device M1 can be an inductor, which is used to reduce the ripple, remove the noise signal, reduce the electromagnetic interference (EMI), and/or converse the power. The magnetic device M1 can be applied to various electronic apparatuses, such as the power supply, the motherboard, the modem, or etc., but it is not limited thereto.

The upper magnetic core 100 has an E-shaped structure. In detail, the upper magnetic core 100 has a top plate 110, two lateral pillars 120, and a first protruding portion 130. Two lateral pillars 120 are connected to the top plate 110, and they are disposed on opposite sides of the top plate 110. The first protruding portion 130 is disposed at the center of the top plate 110, and spaced away from the lateral pillars 120. In this embodiment, the first protruding portion 130 has a cylinder structure. When the upper magnetic core 100 and the lower magnetic core 200 are engaged with each other, two lateral pillars 120 and the first protruding portion 130 extend toward the lower magnetic core 200.

The lower magnetic core 200 also has an E-shaped structure. In detail, the lower magnetic core 200 has a bottom plate 210, two lateral pillars 220, and a second protruding portion 230. Two lateral pillars 220 are connected to the bottom plate 210, and they are disposed on opposite sides of the bottom plate 210. The second protruding portion 230 is disposed at the center of the bottom plate 210, and spaced away from the lateral pillars 220. In this embodiment, the second protruding portion 230 has a cylinder structure. When the upper magnetic core 100 and the lower magnetic core 200 are engaged with each other, two lateral pillars 220 and the second protruding portion 230 extend toward the upper magnetic core 100.

The appearance and the dimensions of the cross-section of the first protruding portion 130 are substantially the same as that of the second protruding portion 230. When the upper magnetic core 100 and the lower magnetic core 200 are engaged, the first protruding portion 130 is aligned with and in contact with the second protruding portion 230, and an accommodating space is formed between them. In this embodiment, the top plate 100, the lateral pillars, and the first protruding portion 130 of the upper magnetic core 100 are integrally formed as one piece, and the bottom plate 210, the lateral pillars 220, and the second protruding portion 230 of the lower magnetic core 200 are integrally formed as one piece. For example, the upper magnetic core 100 and the lower magnetic core 200 can include iron, manganese, zinc, amorphous metal, a combination thereof, or an alloy thereof, but it is not limited thereto.

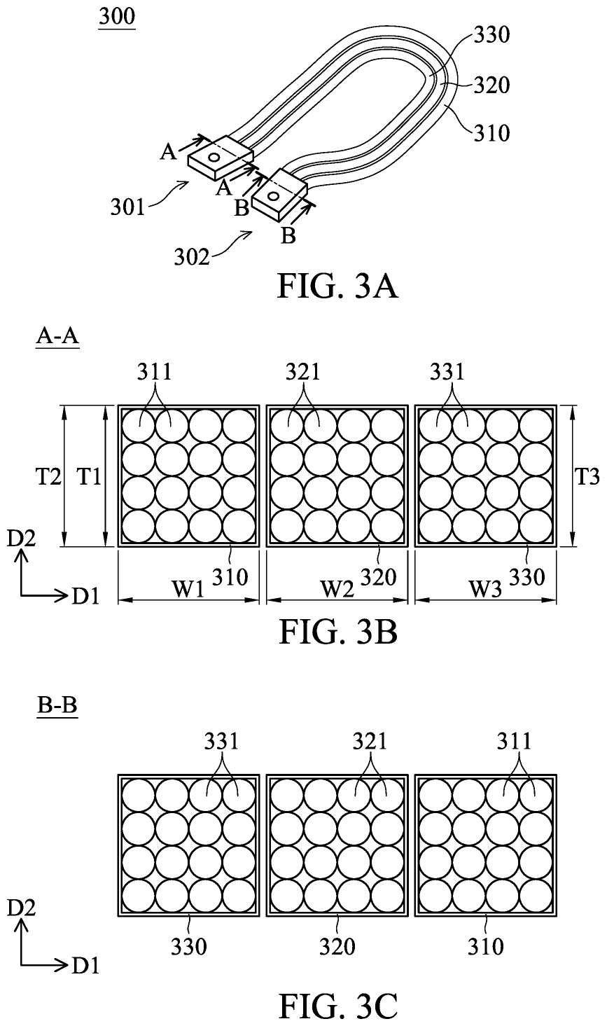

FIG. 3A is a schematic diagram of the press-fit wire 300 used in the magnetic device M1, FIG. 3B is a cross-sectional view taken along the line A-A in FIG. 3A, and FIG. 3C is a cross-sectional view taken along the line B-B in FIG. 3A. As shown in FIG. 3A to FIG. 3C, in this embodiment, the press-fit wire 300 includes a first wire 310, a second wire 320, and a third wire 330. The first wire 310, the second wire 320, and the third wire 330 are parallel to each other and formed as parallel circuits. The first wire 310, the second wire 320, and the third wire 330 are arranged along a first direction D1.

The first wire 310 can be a multi-strand wire having a plurality of first lines 311, and the first lines 311 can be arranged in a matrix. Therefore, the cross-section of the first wire 310 is substantially rectangular. The second wire 320 can be a multi-strand wire having a plurality of second lines 321, and the second lines 321 can be arranged in a matrix. Therefore, the cross-section of the second wire 320 is substantially rectangular. Similarly, the third wire 330 can be a multi-strand wire having a plurality of third lines 331, and the third lines 331 can be arranged in a matrix. Therefore, the cross-section of the third wire 330 is substantially rectangular. It should be noted that, although each of the wires in this embodiment is substantially rectangular because the lines are arranged in a matrix, the lines can be arranged to a circular or a trapezoid as specific required.

During the manufacture of the press-fit wire 300, the first wire 310, the second wire 320, and the third wire 330 can be affixed to each other by adhering (for example, by using varnish or self-adhesive thread), and can be pressed fit and shaped after adhering. Thus, the press-fit wire 300 used in the magnetic device M1 can be formed. It should be noted that, beside the method of adhering, other shaping method can be also used. For example, the wires can be affixed to each other by welding.

Specifically, in a second direction D2 that is perpendicular to the first direction D1, the thickness T1 of the first wire 310 is the same as the thickness T2 of the second wire 320 and the thickness T3 of the third wire 330, so that the whole thickness of the press-fit wire 300 can be restricted, and the miniaturization of the magnetic device M1 can be facilitated. In this embodiment, in the first direction D1, the width W1 of the first wire 310 is the same as the width W2 of the second wire 320 and the width W3 of the third wire 330, and the number of first lines 311 in the first wire 310 is the same as the number of second lines 321 in the second wire 320 and the number of third lines 331 in the third wire 330. Therefore, the cross-sectional structures of the first wire 310, the second wire 320, and the third wires 330 can be totally the same. However, it should be noted that, when the widths and the thicknesses of the wires are the same, and the diameters of the lines are different, the cross-sectional structures are different. On the other hand, when the numbers of the lines are the same, and the diameters of the lines are different, the width and the thickness of each of the wires are different, and the cross-sectional structures are different.

Furthermore, as shown in FIG. 3A to FIG. 3C, since the first wire 310, the second wire 320, and the third wire 330 are not staggered when they extend from the first end 301 to the second end 302, the second wire 320 is disposed between the first wire 310 and the third wire 330 both at the first end 301 and the second end 302.

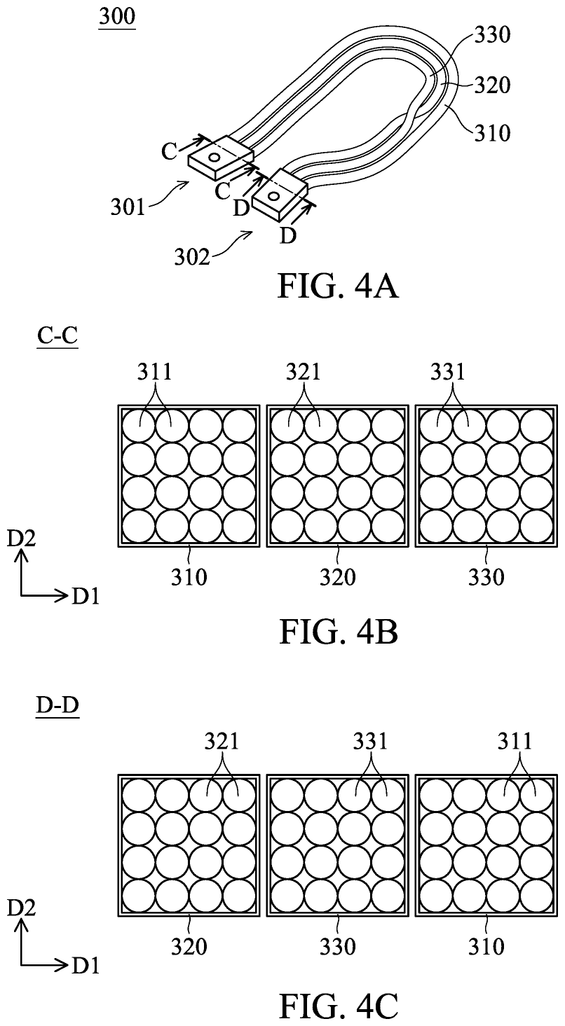

As shown in FIG. 4A to FIG. 4C, in another embodiment of the invention, the second wire 320 and the third wire 330 are staggered when they extend from the first end 301 to the second end 302, so that their order is different at the first end 301 than it is at the second end 302. At the first end 301, the second wire 320 is disposed between the first wire 310 and the third wire 330. At the second end 302, the third wire 330 is disposed between the first wire 310 and the second wire 320.

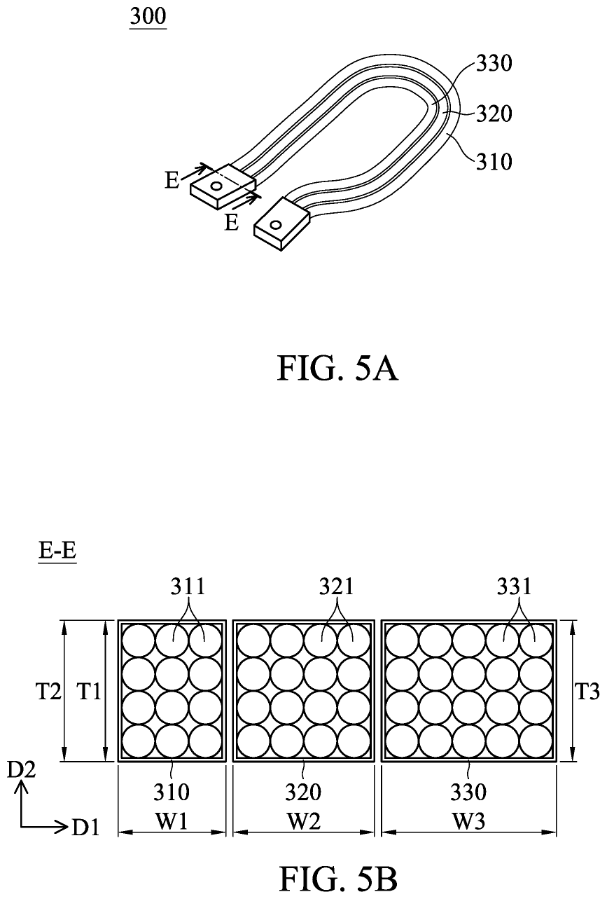

As shown in FIG. 5A and FIG. 5B, in another embodiment, the number of first lines 311 in the first wire 310 is different from the number of second lines 321 in the second wire 320 and the number of third lines 331 in the third wire 330, and the number of second lines 321 in the second wire 320 is different from the number of third lines 331 in the third wire 330. Therefore, the cross-sectional areas of the first wire 310, the second wire 320, and the third wire 330 are different.

In detail, in this embodiment, the number of third lines 331 in the third wire 330 is larger than the number of second lines 321 in the second wire 320, and the number of second lines 321 in the second wire 320 is larger than the number of first lines 311 in the first wire 310. Therefore, the cross-sectional area of the third wire 330 is larger than that of the second wire 320, and the cross-sectional area of the second wire 320 is larger than that of the first wire 310. It should be noted that, in this embodiment, the first wire 310, the second wire 320, and the third wire 330 are merely different in theirs widths W1, W2, and W3. Theirs thicknesses T1, T2, and T3 are still the same, so that the whole thickness of the press-fit wire 300 can be still restricted, and the miniaturization of the magnetic device M1 can be facilitated. Moreover, owing to the engagement of the multi-strand wires with different lines, the current density can be efficiently adjusted.

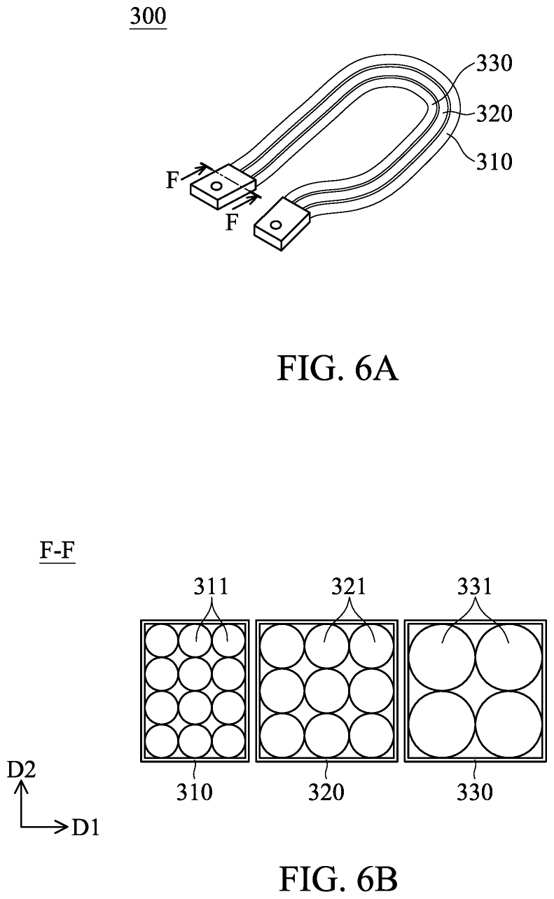

Referring to FIG. 6A and FIG. 6B, in another embodiment of the invention, the diameter of each of the first lines 311 in the first wire 310, the diameter of each of the second lines 321 in the second wire 320, and/or the diameter of each of the third lines 331 in the third wire 330 can be different. In some embodiments, the first wire 310, the second wire 320, and/or the third wire 330 can include a single line. The single line can be a single strand wire or a single core wire. The wires can be arranged with the mixture of the multi-strand wire and a single line. The diameter of the lines in each wire can be different. These method can be used to adjust the current density as required.

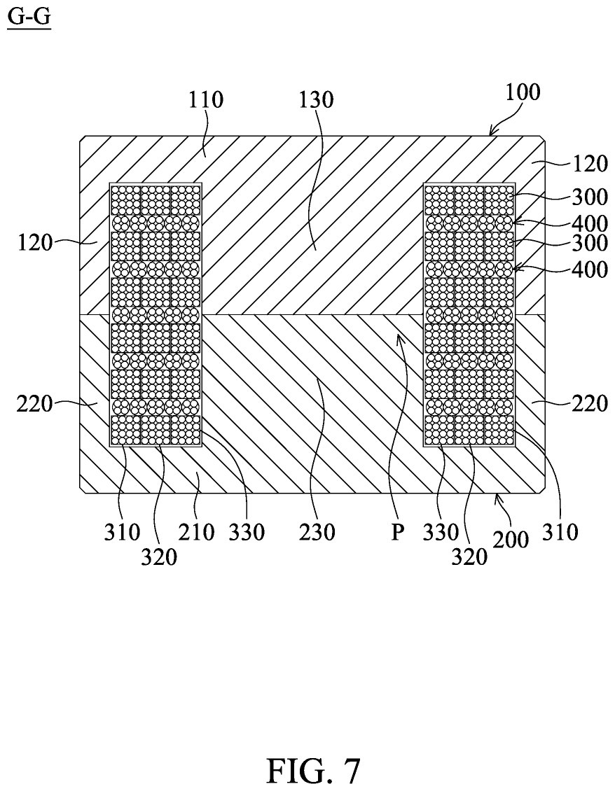

FIG. 7 is a cross-sectional view taken along the line G-G in FIG. 1. As shown in FIG. 7, when the magnetic device M1 is assembled, the first protruding portion 130 of the upper magnetic core 100 and the second protruding portion 230 of the lower magnetic core 200 can form a central pillar P, and the press-fit wire 300 and the coil 400 can be disposed around the central pillar P in a stacked manner. In detail, the third wire 330 can surround the central pillar P, and the first wire 310 can surround the second wire 320. In other words, the wires are expanded side by side along the width direction (the first direction D1), so that the thickness of the magnetic device M1 can be efficiently reduced.

In this embodiment, the coil 400 also surrounds the central pillar P, and the coil 400 and the press-fit wire 300 are arranged in a staggered manner in the thickness direction of the press-fit wire 300 (the second direction D2). In some embodiments, the coil 400 can be omitted to further miniaturize the magnetic device M1.

Since the press-fit wire 300 in this embodiment include a plurality of multi-strand wires, so that the skin depth and the proximity effect can be reduced, and the alternating current (AC) loss can be therefore reduced.

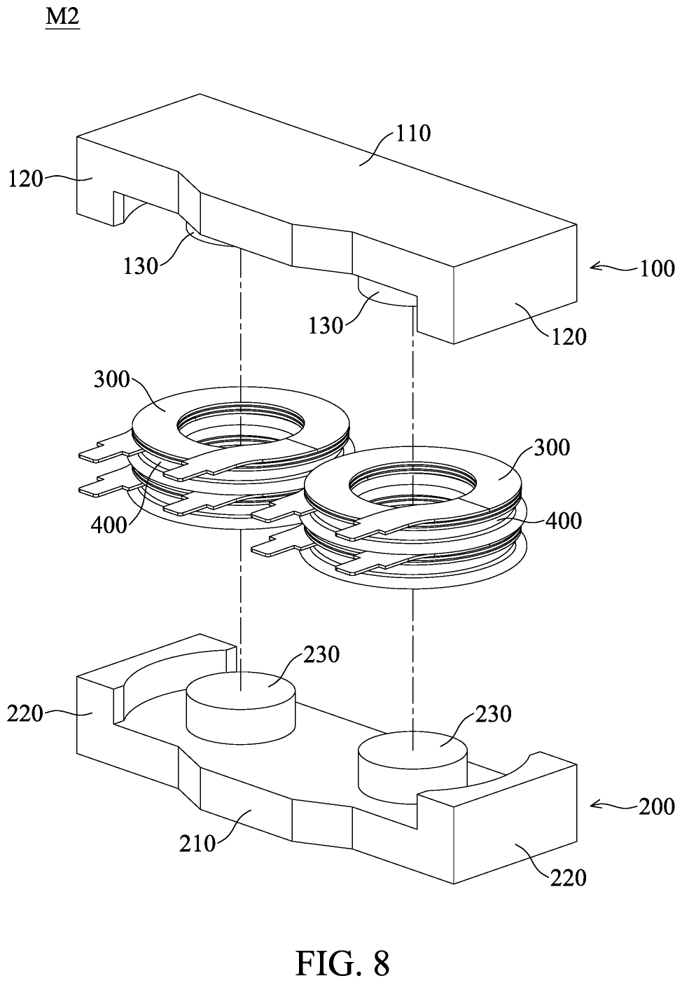

FIG. 8 is a schematic diagram of a magnetic device M2 according to another embodiment of the invention. In this embodiment, the upper magnetic core 100 has a plurality of first protruding portions 130, and the lower magnetic core 200 has a plurality of second protruding portions 230, so a plurality of central pillars can be therefore formed. The press-fit wire 300 and the coil 400 can surround the central pillars formed by the first protruding portions 130 and the second protruding portions 230. Since the press-fit wire 300 used in the magnetic device M2 is the same as the press-fit wire 300 used in the magnetic device M1, the purpose of the miniaturization of the magnetic device M2 can be al so achieved.

In the aforementioned embodiments, the press-fit wire 300 used in the magnetic devices M1 and M2 includes three wires (the first wire 310, the second wire 320, and the third wire 330). It should be noted that, the user can also use the press-fit wire including more than three wires. Moreover, the magnetic devices M1 and M2 can also have the mixture arrangement of the press-fit wire and a normal winding or a copper sheet.

The features between the aforementioned embodiments can be used or combined as long as they do not violate the spirit or conflict.

In summary, a press-fit wire disposed in a magnetic device is provided, including a first wire and a second wire attached to the first wire. The first wire and the second wire are arranged along a first direction and are parallel circuits. The first wire and/or the second wire is a multi-strand wire.

A magnetic device is also provided, including an upper magnetic core, a lower magnetic core, and the aforementioned press-fit wire. The upper magnetic core and the lower magnetic core respectively include a first protruding portion and a second protruding portion. The first protruding portion and the second protruding portion form a central pillar, and the press-fit wire surrounds the central pillar.

Although some embodiments of the present disclosure and their advantages have been described in detail, it should be understood that various changes, substitutions and alterations can be made herein without departing from the spirit and scope of the disclosure as defined by the appended claims. For example, it will be readily understood by those skilled in the art that many of the features, functions, processes, and materials described herein may be varied while remaining within the scope of the present disclosure. Moreover, the scope of the present application is not intended to be limited to the particular embodiments of the process, machine, manufacture, compositions of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps. Moreover, the scope of the appended claims should be accorded the broadest interpretation so as to encompass all such modifications and similar arrangements.

While the invention has been described by way of example and in terms of preferred embodiment, it should be understood that the invention is not limited thereto. On the contrary, it is intended to cover various modifications and similar arrangements (as would be apparent to those skilled in the art). Therefore, the scope of the appended claims should be accorded the broadest interpretation to encompass all such modifications and similar arrangements.

What is claimed is:

1. A press-fit wire disposed in a magnetic device, comprising:
a first wire; and
a second wire, attached to the first wire, wherein the first wire and the second wire are arranged along a first direction, and the first wire and the second wire are parallel circuits, wherein at least one of the first wire and the second wire is a multi-strand wire.

2. The press-fit wire as claimed in claim 1, wherein the first wire is a multi-strand wire having a plurality of first lines, and the first lines are arranged in a matrix.

3. The press-fit wire as claimed in claim 2, wherein the second wire is a multi-strand wire having a plurality of second lines, the second lines are arranged in a matrix, and the number of second lines is the same as the number of first lines.

4. The press-fit wire as claimed in claim 3, wherein the diameter of each of the first lines is different from the diameter of each of the second lines.

5. The press-fit wire as claimed in claim 2, wherein the second wire is a multi-strand wire having a plurality of second lines, the second lines are arranged in a matrix, and the number of second lines is different from the number of first lines.

6. The press-fit wire as claimed in claim 1, wherein the first wire has at least one first line, the second wire has at least one second line, and the diameter of the first line is different from the diameter of the second line.

7. The press-fit wire as claimed in claim 1, wherein the first wire or the second wire has a single line.

8. The press-fit wire as claimed in claim 7, wherein the single line is a single strand wire or a single core wire.

9. The press-fit wire as claimed in claim 1, wherein the press-fit wire further comprises a third wire, and the first wire, the second wire, and the third wire are arranged along the first direction.

10. The press-fit wire as claimed in claim 9, wherein the press-fit wire has a first end and a second end opposite to the first end, the second wire is disposed between the first wire and the third wire at the first end, and the second wire is disposed between the first wire and the third wire at the second end.

11. The press-fit wire as claimed in claim 9, wherein the press-fit wire has a first end and a second end opposite to the first end, the second wire is disposed between the first wire and the third wire at the first end, and the third wire is disposed between the first wire and the second wire at the second end.

12. The press-fit wire as claimed in claim 1, wherein the first wire and the second wire are affixed to each other by adhering or welding.

13. The press-fit wire as claimed in claim 1, wherein in a second direction that is perpendicular to the first direction, the first wire and the second wire substantially have the same height.

14. The press-fit wire as claimed in claim 13, wherein the first wire has at least one first line, the second wire has at least one second line, and the diameter of the first line is different from the diameter of the second line.

15. A magnetic device, comprising:
an upper magnetic core, having a first protruding portion;
a lower magnetic core, having a second protruding portion, wherein the first protruding portion and the second protruding portion form a central pillar; and
at least one press-fit wire, surrounding the central pillar and comprising:
a first wire; and
a second wire, attached to the first wire, wherein the first wire and the second wire are arranged along a first direction, and the first wire and the second wire are parallel circuits, wherein at least one of the first wire and the second wire is a multi-strand wire.

16. The magnetic device as claimed in claim 15, wherein the first wire is a multi-strand wire having a plurality of first lines, and the first lines are arranged in a matrix.

17. The magnetic device as claimed in claim 16, wherein the second wire is a multi-strand wire having a plurality of second lines, the second lines are arranged in a matrix, and the number of second lines is the same as the number of first lines.

18. The magnetic device as claimed in claim 16, wherein the second wire is a multi-strand wire having a plurality of second lines, the second lines are arranged in a matrix, and the number of second lines is different from the number of first lines.

19. The magnetic device as claimed in claim 15, wherein the first wire has at least one first line, the second wire has at least one second line, and the diameter of the first line is different from the diameter of the second line.

20. The magnetic device as claimed in claim 15, wherein the first wire or the second wire has a single line.

21. The magnetic device as claimed in claim 15, wherein the press-fit wire further comprises a third wire, and the first wire, the second wire, and the third wire are arranged along the first direction.

22. The magnetic device as claimed in claim 21, wherein the press-fit wire has a first end and a second end opposite to the first end, the second wire is disposed between the first wire and the third wire at the first end, and the second wire is disposed between the first wire and the third wire at the second end.

23. The magnetic device as claimed in claim 21, wherein the press-fit wire has a first end and a second end opposite to the first end, the second wire is disposed between the first wire and the third wire at the first end, and the third wire is disposed between the first wire and the second wire at the second end.

24. The magnetic device as claimed in claim 15, wherein the first wire and the second wire are affixed to each other by adhering or welding.

25. The magnetic device as claimed in claim 15, wherein in a second direction that is perpendicular to the first direction, the first wire and the second wire substantially have the same height.

26. The magnetic device as claimed in claim 15, wherein the press-fit wire further comprises a third wire, the third wire surrounds the central pillar, the second wire surrounds the third wire, and the first wire surrounds the second wire.

27. The magnetic device as claimed in claim 15, wherein the magnetic device further comprises a coil surrounding the central pillar, and the press-fit wire and the coil are arranged in a stacked manner.

28. The magnetic device as claimed in claim 27, wherein the magnetic device further comprises a copper sheet, and the press-fit wire, the coil, and the copper sheet are arranged along a second direction, wherein the second direction is substantially perpendicular to the first direction.
